(19) United States
(12) Patent Application Publication
(10) Pub. No.: US 2010/0309442 A1
(43) Pub. Date: Dec. 9, 2010

(54) MOBILE COMMUNICATION DEVICE WITH BUILT-IN PROJECTING SCREEN

(75) Inventor: Prasad Sharan Sadhu, Patna (IN)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/478,798

(22) Filed: Jun. 5, 2009

(51) Int. Cl. G03B 21/10

(52) U.S. Cl. 353/79

(57) ABSTRACT

The invention relates to a mobile communication device comprising a casing, at least one image projecting device, and a projecting screen. The image projecting device in the mobile communication device is adapted to project an image on the projecting screen.

### TECHNICAL FIELD

The present invention relates to the field of portable electronic devices and, in particularly, to a mobile communication device using a projector and a projecting screen to get a large display screen in a small size device. The present invention especially targets the area of mobile communication devices, such as mobile phones, where a larger viewing screen is highly sought for.

### BACKGROUND

In today's society almost everybody owns and uses a mobile communication device, such as a mobile phone.

During the last decade the mobile phone has evolved from being a bulky device only used for making phone calls with, to be a small sized fully fletched entertainment device capable of playing and showing all sorts of media files. However, making the portable communication device smaller in size and at the same time gear the usage of the device towards activities that is best undertaken on a large display screen, such as watching movies, surfing the Internet, working with documents etc., are contrary to each other. Therefore, finding a way of providing a larger display screen than the built-in display screen in a small sized phone, without effecting phones size or its design, is highly sought for.

### SUMMARY OF THE INVENTION

With the above description in mind, then, an aspect of the present invention is to provide a way of increasing the display screen in a small sized mobile communication device without effecting the design or size of the device, and in that way mitigate, alleviate, or eliminate one or more of the above-identified deficiencies in the art and disadvantages singly or in any combination.

As will be described in more detail by the aspects of the present invention below, one way to provide such a way of increasing the display screen in a small sized mobile communication device without effecting the size and the design of the device is to incorporate a image projecting device together with a projecting screen that is considerably larger than the built-in display in the mobile phone.

An aspect of the present invention relates to a method for a mobile communication device comprising a casing, at least one image projecting device, and a projecting screen, wherein said image projecting device is adapted to project an image on said projecting screen.

The method may further comprise that the casing further comprise a first and a second part, wherein said first part house said image projecting device, and said second part house said projecting screen, and wherein said first part is movable in relation to said second part.

The method may further comprise that the casing further comprise a first and a second part, wherein said first part house said image projecting device and said projecting screen.

The method may further comprise that the projecting screen is movable between a display position and a stored position.

The method may further comprise that said projecting screen is stored inside said casing.

The method may further comprise that said projecting image projecting device is movable between a display position and a stored position.

The method may further comprise that said image projecting device is stored inside said casing.

The method may further comprise that said projecting screen is arranged in a rolled up state in said stored position.

The method may further comprise that said projecting screen is arranged in a folded state in said stored position.

The method may further comprise that said projecting screen is adapted to be arranged and changeable between a first and a second state, wherein the screen is flexible in said first state and rigid in said second state.

The method may further comprise input means for receiving multi media data for displaying on said projecting screen, a memory for storing received multi media data, and processing means for processing said stored multimedia data and for sending processed multimedia data to said image projecting device.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows the front side of a portable communication device, in this case a brick type mobile phone; and

FIG. 2 shows another type of portable communication device, in this case a clam type mobile phone; and

FIG. 3 shows a clam type mobile phone with an extendable projecting screen according to the present invention; and

FIG. 4a shows a front view of a clam type mobile phone with the projecting screen extended and the image projecting device projecting an image onto the projecting screen; and

FIG. 4b shows a side view of a clam type mobile phone with the projecting screen extended and the image projecting device projecting an image onto the projecting screen; and

FIG. 5a shows a front view of a brick type mobile phone with the projecting screen extended and the image projecting device projecting an image onto the projecting screen; and

FIG. 5b shows a side view of a brick type mobile phone with the projecting screen extended and the image projecting device projecting an image onto the projecting screen; and

FIG. 5c shows a side view of a brick type mobile phone with the projecting screen extended and the image projecting device projecting an image onto the projecting screen in a back projection manner; and

FIG. 6 shows a side view of a clam type mobile communication device with a image projecting device projecting an image onto a projecting screen according to an embodiment of the present invention; and

FIG. 7 shows a side view of a clam type mobile communication device with a image projecting device projecting an image onto a projecting screen according to another embodiment of the present invention; and

FIG. 8 shows a side view of a clam type mobile communication device with a image projecting device projecting an image onto a projecting screen according to yet another embodiment of the present invention; and

FIG. 9 shows a side view of a clam type mobile communication device with a image projecting device projecting an image onto a projecting screen according to another embodiment of the present invention; and

FIG. 10 shows an example of how the projecting screen may be stored internally inside the casing of the mobile communication device according to the present invention; and

FIG. 11 shows another example of how the projecting screen may be stored internally inside the casing of the mobile communication device according to the present invention; and

FIG. 12 shows yet another example of how the projecting screen may be stored internally inside the casing of the mobile communication device according to the present invention; and

FIG. 13 shows an example of how the projecting screen in a brick type mobile communication device may be moved from an stored position to a display position according to an embodiment of the present invention; and

FIG. 14 shows another example of how the projecting screen in a brick type mobile communication device may be moved from an stored position to a display position according to an embodiment of the present invention; and

FIG. 15a shows back side view of an example of how the projecting screen in a brick type mobile communication device may be moved from an stored position to a display position according to an embodiment of the present invention; and

FIG. 15b shows a side view of an example of how the projecting screen in a brick type mobile communication device may be moved from an stored position to a display position according to an embodiment of the present invention.

### DETAILED DESCRIPTION

Embodiments of the present invention relate, in general, to the field of portable communication devices and, in particularly, to display size and how to display large images in small sized devices.

The embodiments and their variants discussed below relates to a portable communication device, such as a mobile phone. However, it should be appreciated that the invention is as such equally applicable to electronic devices which do not include any radio communication capabilities. Examples of such devices may for instance be global positioning system devices, laptops (such as standard, netbooks, ultraportable, and micro laptops), handheld computers, gaming devices, accessories to mobile phones, keyboards, etc. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

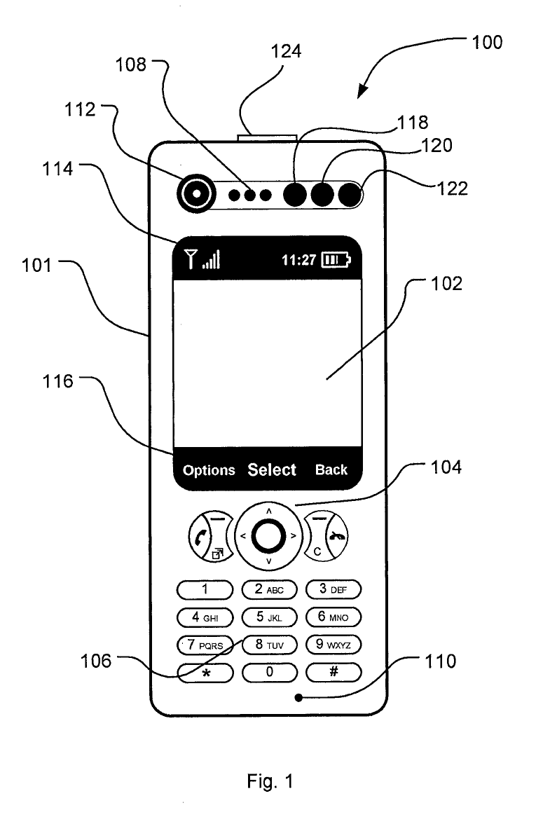

FIG. 1 shows the front side of an brick type portable or mobile communication device, in this case a mobile phone 100, comprising a casing 101, a display screen or display area 102 (usually a LCD, LED or OLED screen), and means 104 for navigating among items (not shown) displayed in the display area. The casing 101 may be made of any type of casing material such as painted or not painted plastic, metal, glass, polymer material, or a combination thereof. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile phone 100 can also comprise other elements normally present in such a device, such as a keypad 106, a speaker 108, a microphone 110, a camera 112, a photo sensor 118 (e.g. ambient light), a infrared light (IR) sensor 120, infrared light emitting diode 122 (IR LED), processing means (not shown), memory means (not shown), one or more accelerometers (not shown), a vibration device (not shown), an AM/FM radio transmitter and receiver (not shown), a digital audio broadcast transmitter and receiver (not shown), a Bluetooth device (not shown), an antenna module (not shown), etc. The portable communication device in FIG. 1 may also house an image projecting device (a projector) 124 which is capable of projecting an image on a surface.

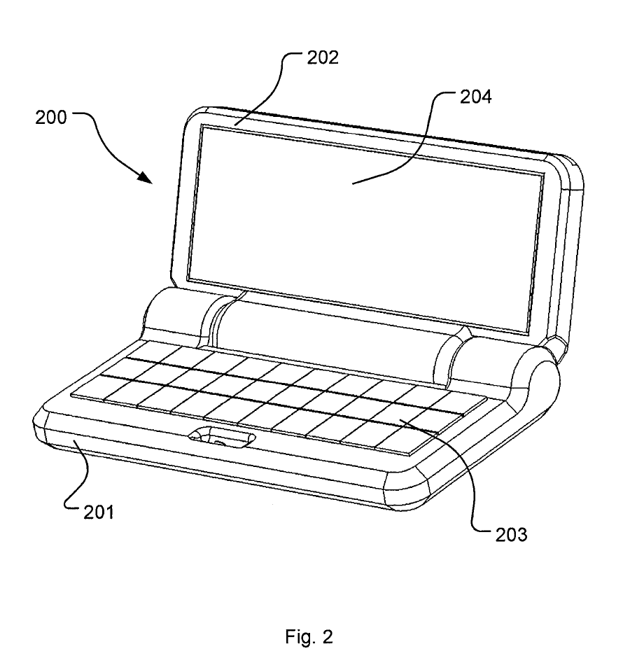

FIG. 2 shows another type or design of an ordinary mobile communication device 200, often referred to as a clam type mobile phone, having a two-part casing, a first part 201 casing and a second part 202 casing, wherein the parts are attached and movable in relation to each other. The mobile communication device 200 may also house a display area 204, and navigation means 203. The communication device in 200 may also incorporate all or some of the technical features discussed in conjunction with the mobile communication device 100 in FIG. 1.

The embodiments of the present invention will now be discussed in relation to the two types of mobile communication devices described and shown in FIGS. 1 and 2.

The wording ‘displayed image’ in below description should be interpreted as being a still image, a movie (moving image), a 2D-image, a 3D-image, or any combination thereof.

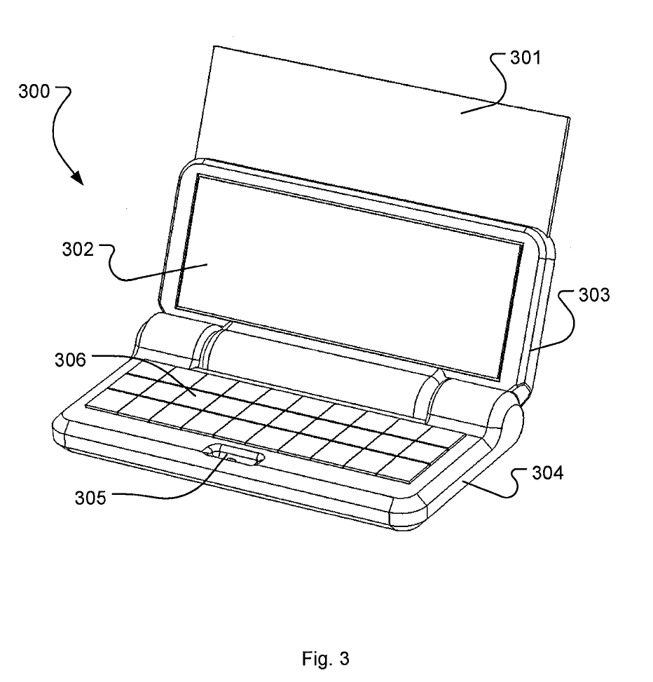

FIG. 3 shows an embodiment of the present invention comprising a mobile communication device 300, in this case a clam type mobile phone, having a two-part casing, a first part 304 casing and a second part 303 casing, a display area or display screen 302, and navigation means 306. The communication device 300 has been fitted with a projecting screen 301 and a projecting device 305, capable of projecting an image onto the projecting screen 301.

The projecting screen 301 is extendable/retractable/movable between a stored position, where the projecting screen 301 is entirely (or in some cases partially) inside the casing of the mobile communication device 300, in this case the second part of the devices casing 303, and a display position where the projecting screen is entirely (or in some cases partially) extending out from the casing of the mobile communication device. In this way the extendable projecting screen 301 may act as a display area in the same way as the built-in display screen 302. The projecting screen may be smaller, larger or the same size as the built-in display screen 302. The content displayed on the projecting screen 301 may or may not be the same content as shown on in the display screen 302. In one variant the display screen 301 may act as an extension of the built-in display screen 302, while in another variant the projecting screen 301 act as a separate stand-alone display area. In this way the user may have access to both a much larger display area than offered by the built-in display screen, and a secondary display area of the mobile communication device.

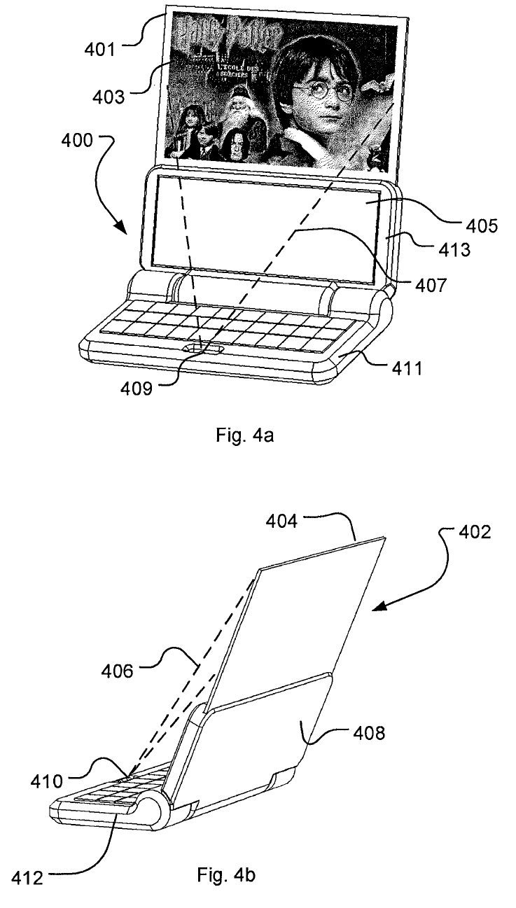

In FIG. 3 the projecting screen extends from the long edge (the edge of the second part 303 not connected to the first part 304) of the second part 303 of the casing of the mobile communication device, but in an alternative version the projecting screen may extend from one, or both, of the short edges on the second part 303 of the casing instead. When the projecting screen 301 is in a display position, as shown in the embodiment of the present invention in FIG. 3, the image projecting device 305 may project an image onto the projecting screen, as shown in FIGS. 4a and 4b. Thus, the user has access to a much larger display area 301 than the built-in display area of the mobile communication device 302.

FIG. 4a shows a mobile communication device 400 where the projecting device 409, situated in the first part of the casing 411, projects 407 (indicated by the dotted lines) an image of the Harry Potter 403 movie onto the projecting screen 401 which is extending from the second part of the casing 413. In the example in FIG. 4a the built-in display screen 405 is not used since the much larger projecting screen is used to watch a movie on. However, information (title, length of movie, cast and credits list, etc.), menus and software navigation means may be simultaneously displayed in the display screen 405 of the mobile communication device 400. In one variant the movie (two identical images) is shown on both the display screen 405 and the projecting screen 403, and in yet another variant the movie is stretched so that part of the movie is shown on the display screen 405 and the other part is shown on the projecting screen 403.

FIG. 4b shows the same embodiment of the present invention as discussed in conjunction with FIGS. 3 and 4a but from a back-side view. In this view it can clearly be seen that the projecting screen 404 extends from the long edge of the second part of the casing 408 of the mobile communication device. The projecting device 410 situated just below the navigation means on the first part of the casing 412 projects 406 an image onto the projecting screen 404.

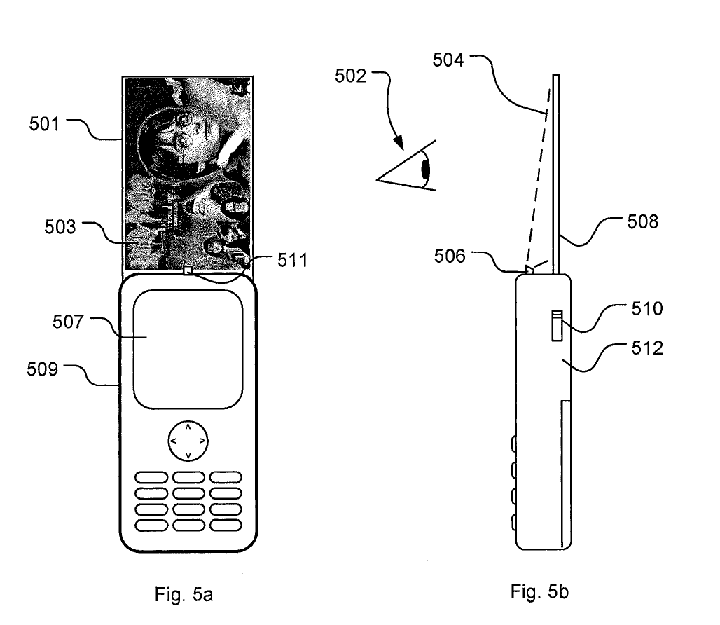

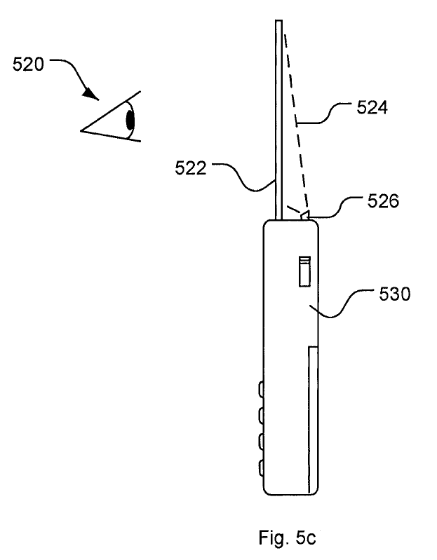

The same concept of using an extendable projecting screen extending from the casing together with a projecting device to get a larger display area may be used in a non-clam type (i.e. brick-like) mobile communication device. FIGS. 5a and 5b show an embodiment of how the present invention may be applied to such a brick type mobile. The extendable projecting screen 501 in this embodiment is also stored inside the casing 509 of the mobile communication device. FIG. 4a shows a front-view of when the projecting screen 501 is in a display position. The built-in projecting device 511 is in this embodiment projecting an image of the Harry Potter movie 503 onto the projecting screen 501. The projecting screen 501 and the projecting device 511 may act as an extension to the built-in display screen 507 of the mobile communication device or may act as a stand-alone display area, displaying content from the communication device.

FIG. 5b shows a side-view of the embodiment illustrated and described in FIG. 5a. In FIG. 5b it is clearly shown how the projecting device 506 projects 504 an image onto the extended projecting screen 508 when it is in its display position. The mobile communication unit may be fitted with maneuvering means 510 for maneuvering the projecting screen between a stored position inside the casing 512 of the mobile communication device and a display position wherein the projecting screen 508 fully extends from the mobile communication devices casing 512 (as illustrated in the figure). The eye 502 in the figure illustrates from which direction the user of the mobile communication device is meant to watch the displayed image on the projecting screen 508.

FIG. 5c shows an alternative of the embodiment of the present invention illustrated in FIGS. 5a and 5b. In this variant the image projected 524 by the projecting device 526 onto the projecting screen 522 extending from the mobile communication devices casing 530 is projecting the image from another direction compared to the variants discussed in conjunction with FIGS. 5a and 5b. In FIGS. 5a and 5b the image is projected 504 onto the projecting screen 508 from the same direction as the user 502, when watching the projected image on the projecting screen. In this way the user will actually see the reflection of the projected image on the projection screen, so called front or reflective projection. In the variant in FIG. 5c the image is projected 524 towards the user 520 onto the projecting screen 522. In this way the user will see the image transmitted through the projection screen, so called back-projection.

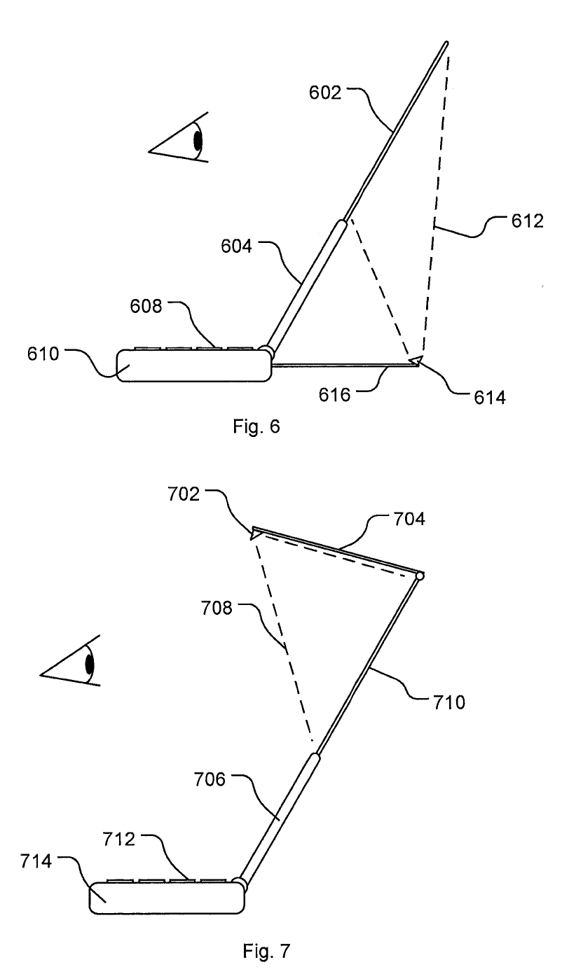

FIG. 6 shows another embodiment of the present invention comprising a clam-type mobile communication device with navigation means 608 arranged in the first part 610 of the casing and a built-in display a screen and extendable projecting screen 602 in the second part 604 of the casing. In this embodiment the image projecting device 614 may be arranged on a semi-rigid or rigid bar/rod/stick or other protruding part (telescopic or non-telescopic) 616 (hereinafter referred to only as a rod) which may be movable between a display position and a stored position. FIG. 6 shows the projecting device arranged on a rod 616 in a display position. The image projecting device may be moved into a stored position completely or partial inside the first part 610 of the casing. The image projecting device is extendable in such a way that it may project an image 612 onto the back (from the user's point of view) of the projecting screen 602, projecting an image through a back-projection technique. In contrast to the embodiment of the present invention presented in FIG. 3, the user may freely operate the navigation means 608 without risking blocking the projected image 612 of the projecting device 614 with his body parts (i.e. hands) or other navigation means.

FIG. 7 shows yet another embodiment of the present invention comprising a clam-type mobile communication device with navigation means 712 arranged in the first part 714 of the casing and a built-in display screen and extendable projecting screen 710 in the second part 706 of the casing. The image projection device 702 may in this embodiment be arranged on a semi-rigid or rigid bar/rod/stick or other protruding part (telescopic or non-telescopic) 704 arranged on the projecting screen 710. When the projecting screen is in a display position the image projecting device 702 may be extendable in such a way that it may project an image 708 onto the front (from the user's point of view) of the projecting screen 710. When the image projecting device 702 and the projecting screen 710 is to be stored inside the second part of the casing 706, the image projecting device is moved into a stored position close to the projecting screen, which then is moved into the second part of the casing 706. In contrast to the embodiment of the present invention presented in FIG. 3, the user may operate the navigation means 712 without risking blocking the projected image 708 of the projecting device with his body parts (i.e. hands) or other navigation means.

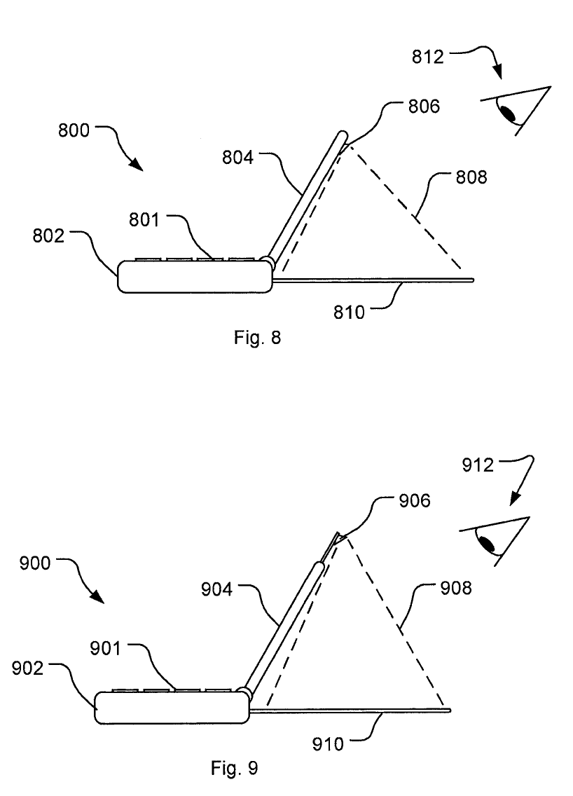

FIG. 8 shows yet another embodiment of the present invention comprising a clam type mobile communication device 800 with navigation means 801 arranged in the first part 802 of the casing and a built-in display screen in the second part 804 of the casing. In this embodiment the image projection device 810 is arranged in the second part 802 of the casing and the projection screen 806 is arranged in the first part 804 of the casing. The image projection device 806 may be moved from a stored position inside the second part 804 of the casing to a display position on or in the vicinity of the second part 804 of the casing. The projection screen 810 may be moved from a stored position inside the first part 802 of the casing into a display position as shown in the figure. The Image projecting device 806 in its display position on the second part of the casing may then project 808 an image onto the projecting screen 810 in its display position. In this embodiment the user, shown as an eye 812 in the figure, need to be placed behind the mobile communication device in order to view the image displayed on the projecting screen. In this way the user will not be able to watch the built-in screen in the same time as the user watches the image projected onto the projecting screen.

FIG. 9 shows yet another embodiment of the present invention comprising a clam-type mobile communication device 900 with navigation means 901 arranged in the first part 902 of the casing and a built-in display screen in the second part 904 of the casing. In this embodiment the image projection device 906 is arranged on a semi-rigid or rigid bar/rod/stick or other protruding part (telescopic or non-telescopic) arranged on in the second part 904 of the casing and the projection screen is arranged in the first part 902 of the casing. The image projection device 906 may be moved from a stored position inside the second part 904 of the casing to a display position as shown by the figure. The projection screen 910 may be moved from a stored position inside the first part 902 of the casing into a display position as shown in the figure. The Image projecting device 906 in its display position on the second part 904 of the casing may then project an image 908 onto the projecting screen 910 in its display position. In this embodiment the user, shown as an eye 912 in the figure, need to be placed behind the mobile communication device in order to view the image displayed on the projecting screen. In this way the user will not be able to watch the built-in screen in the same time as the user watches the image projected onto the projecting screen.

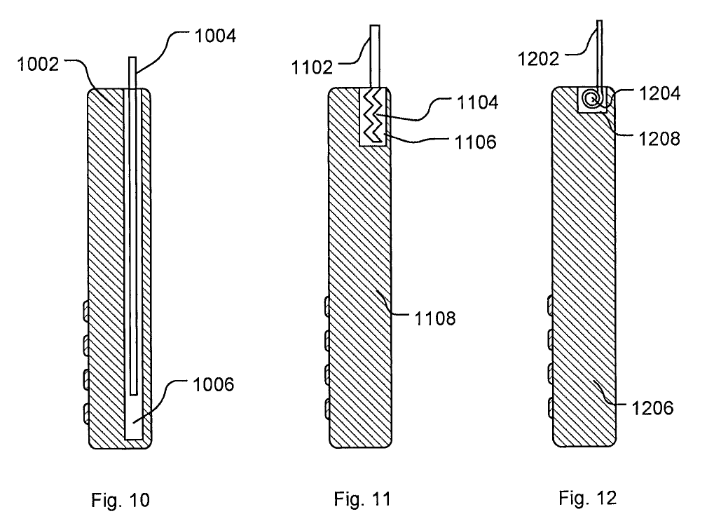

The projecting screen may be stored in several different ways inside the casing of the mobile communication device. FIG. 10 shows an exploded side-view of a mobile communication device illustrating one way of storing the projecting screen inside the casing 1002. If the projecting screen 1004 is made out of a rigid or semi-rigid material and can not be collapsible the interior storing pocket 1006 must be able to accommodate the full length and width of the projecting screen. The projecting screen 1004 may then by hand or by any mechanical or electromechanical technique be moved out or inside the storing pocket inside the mobile communication casing.

In another variant shown in the exploded side-view of the mobile communication device in FIG. 11, the projecting screen 1102 may, if made be a collapsible material, be folded 1104 into a storing pocket 1106 in the mobile communication devices casing 1108. In this variant the material of the projecting screen may be changed between a rigid state, when in a display position, and a flexible and collapsible state, when in a stored state. This variant may in some cases consume less internal space inside the casing of the mobile communication device in comparison with the variant shown in FIG. 10 and FIG. 12.

In yet another variant shown in the exploded side-view of the mobile communication device in FIG. 12, the projecting screen 1202 may, if made be a collapsible material, be rolled up into a roll 1204 in the storing pocket 1208 in the mobile communication devices casing 1206. In this variant the material of the projecting screen may be changed between a rigid state, when in a display position, and a flexible and collapsible state, when in a stored state. This variant may in some cases consume less internal space inside the casing of the mobile communication device in comparison with the variant shown in FIG. 10 and FIG. 11.

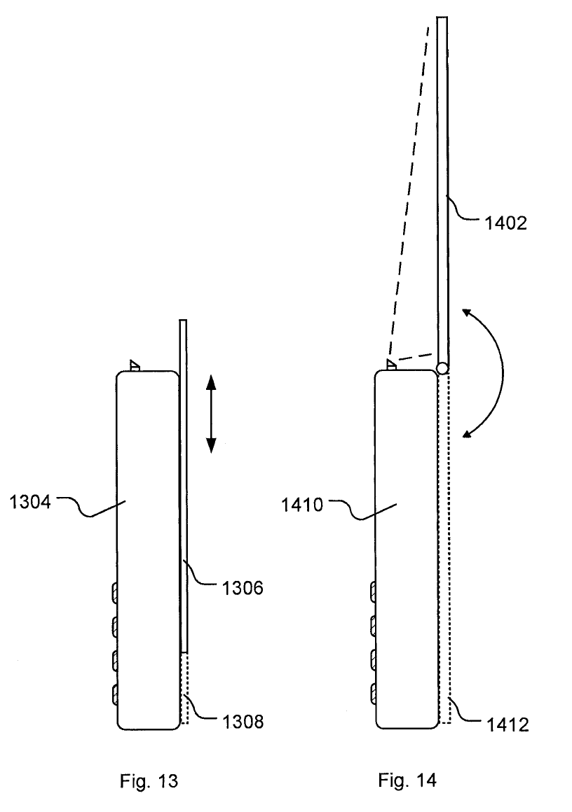

FIG. 13 shows a variant of arranging the projecting screen 1306 on the casing 1304 of the mobile communication device. In this example the projection screen 1306 may be made of a rigid or semi-rigid material and stored on the outer side of the casing 1304 of the mobile communication device. The projection screen will cover the entire back of the casing (or being a part of the casing itself) and the projection screen is moved into a display position by sliding it up along the backside of the casing 1304 as shown in the figure. When the projection screen is to be stored the projections screen is slided back down 1308 on the back-side of the mobile communication device.

FIG. 14 shows yet another variant of how the projecting screen 1402 may be arranged on the outer side of the casing 1410 of the mobile communication device. In this variant the projecting screen 1402 is arranged in a way that it may be folded up (from 1412 to 1402 and vise versa) into a display position and folded down into a stored position as illustrated in the figure.

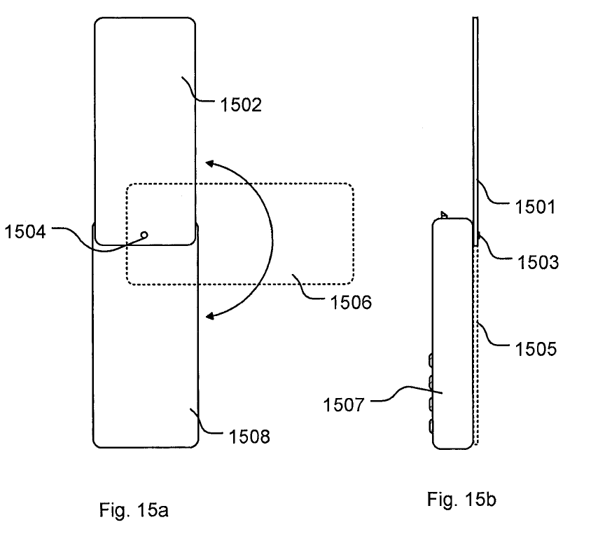

FIG. 15a shows yet another variant of how the projecting screen 1502 may be arranged on the outer side of the casing 1508 of the mobile communication device. In this variant the projecting screen 1502 is arranged in a way that it may be slided up in a 180 degree circle (from 1508 to 1502 via 1506) into a display position and slided down (in a 180 degree circle) into a stored position as illustrated in the figure. The sliding motion may be done along a 180 degree circle in reference to an attachment point 1504. FIG. 15b shows the variant in 15a from a side-view where it clearly can be seen how the projecting screen 1501 is slided up into a display position from a stored position 1505 around the attachment point 1503 on the outer backside of the casing 1507 of the mobile communication device.

In the embodiments shown in FIGS. 3, 4, 5, 8, 13, and 14 the image projecting device may either be arranged in such way that it is always in a display position or it may be arranged in such a way that it may be moved into a stored position inside the casing of the mobile communication device.

All movements of the image projecting device and the projecting screen from their stored position to their display position, and vise versa, described in conjunctions with the embodiments above, may be done either manually by the user using some mechanical structure or device, or automatically, using some electromechanical structure or device controlled by the navigation means on the mobile communication device.

The invention is not limited to the examples discussed above. For example the projecting screen sliding up along the back towards one of the short sides of the brick-like mobile communication device in FIG. 13, may in another variant slide up along the back towards one of the long sides of the brick-like mobile communication device (towards or from you in the figure).

The mobile communication device fitted with the present invention may for instance be used to watch multimedia files on. The larger screen will add to the user experience of the mobile communication device. The mobile communication device may also comprise means for receiving multi media data from internal and external sources for displaying on the projection screen. The received multimedia data may be stored internally in a memory or in a removable storage media. Internal processing means may then process the stored multimedia data and send it to the image projection device which will project the processed multimedia data onto the projecting screen. The projected multimedia data may then be viewed by the user on the projecting screen.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A mobile communication device comprising:
a casing;
at least one image projecting device; and
a projecting screen, wherein said image projecting device is adapted to project an image on said projecting screen.

2. The communication device according to claim 1, wherein the casing further comprise a first and a second part, wherein said first part house said image projecting device, and said second part house said projecting screen, and wherein said first part is movable in relation to said second part.

3. The communication device according to claim 1, wherein said casing further comprise a first and a second part, wherein said first part house said image projecting device and said projecting screen.

4. The communication device according to claim 1, wherein said projecting screen is movable between a display position and a stored position.

5. The communication device according to claim 1, wherein said projecting screen is stored inside said casing.

6. The communication device according to claim 1, wherein said projecting image projecting device is movable between a display position and a stored position.

7. The communication device according to claim 1, wherein said image projecting device is stored inside said casing.

8. The communication device according to claim 4, wherein said projecting screen is arranged in a rolled up state in said stored position.

9. The communication device according to claim 4, wherein said projecting screen is arranged in a folded state in said stored position.

10. The communication device according to claim 1, wherein said projecting screen is adapted to be arranged and changeable between a first and a second state, wherein the screen is flexible in said first state and rigid in said second state.

11. The communication device according to claim 1, further comprise
input means for receiving multi media data for displaying on said projecting screen;
a memory for storing received multi media data; and
processing means for processing said stored multimedia data and for sending processed multimedia data to said image projecting device.
